(19) United States
(12) Patent Application Publication
(10) Pub. No.: US 2013/0262210 A1
(43) Pub. Date: Oct. 3, 2013

(54) CLOUD SERVICE OR STORAGE USE PROMOTION VIA PARTNERSHIP DRIVEN AUTOMATIC ACCOUNT UPGRADES

(71) Applicants: Brandon Savage, San Carlos, CA (US); Michael Smith, Palo Alto, CA (US); Hieu Nguyen, Redwood City, CA (US)

(72) Inventors: Brandon Savage, San Carlos, CA (US); Michael Smith, Palo Alto, CA (US); Hieu Nguyen, Redwood City, CA (US)

(21) Appl. No.: 13/431,645

(22) Filed: Mar. 27, 2012

(51) Int. Cl. G06Q 30/02

(52) U.S. Cl. 705/14.26; 705/14.1; 705/14.36

(57) ABSTRACT

System and method for cloud service or storage use promotion via partnership driven automatic account upgrades are disclosed. In one aspect, embodiments of the present disclosure include a method, which may be implemented on a system, for receiving a device identifier of a device used to access the cloud service or storage, at a host of the cloud service or storage, and using the device identifier, by the host, to determine whether a promotion currently exists for the device and for identifying details of the promotion. One embodiment further includes, upgrading an account used to access the cloud service or storage in response to determining that the promotion exists. The use of the cloud service or storage can be promoted at the device by a physical or electronic imprint depicting the promotion available when accessed at the device

### BACKGROUND

With the increase of electronic and digital content being used in enterprise settings or other organizations as the preferred mechanism for project, task, and work flow management, as has the need for streamlined collaboration and sharing of digital content and documents, and in particular, via cloud-based services and/or cloud-based storage. Functionalities for downloading, editing, revising, viewing of files and documents have become regularly accessed features of such an online collaboration environment and as such are integral components of a user's perception of system capabilities.

As such, enhanced account features in a cloud-based service streamline a users' experience and can promote use and used to facilitate adoption in an application or environment where large amounts of documents need to be frequently accessed and modified. There thus exists unique opportunities for cloud-based service providers to explore creating additional marketing channels to approach and attract new users.

### BRIEF DESCRIPTION OF THE DRAWINGS

FIG. 1 illustrates an example diagram of a system having a host server of a cloud service and/or cloud storage which is able to promote use and adoption through automatic account upgrades.

FIG. 2 depicts a diagram of a web-based or online collaboration platform deployed in an enterprise or other organizational setting for organizing work items and workspaces, as one example of a hosted cloud service and/or cloud storage in which accounts are automatically upgraded for certain devices.

FIG. 3 depicts an example diagram of a workspace in an online or web-based collaboration environment accessible by multiple collaborators through various devices which may be eligible for account upgrades.

FIG. 4 depicts a block diagram illustrating actions performed between a host server for a cloud-based service and a user device to authorize an automatic account upgrade that is specific to the device.

FIG. 5A depicts a block diagram illustrating an example of components in a host server able to promote the use and adoption of cloud service/storage via partnership driven automatic account upgrades.

FIG. 5B depicts an example of promotions stored with promotion parameters and/or details of the promotion in a promotions database.

FIG. 6 depicts a flow chart illustrating an example process for automatically upgrading an account to cloud-based services and/or storage based on device-specific promotions.

FIG. 7 depicts a flow chart illustrating an example process for promoting use of cloud service and/or storage through partnership-driven automatic account upgrades.

FIG. 8 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for promoting use of cloud services and/or cloud storage via partnership driven automatic account upgrades.

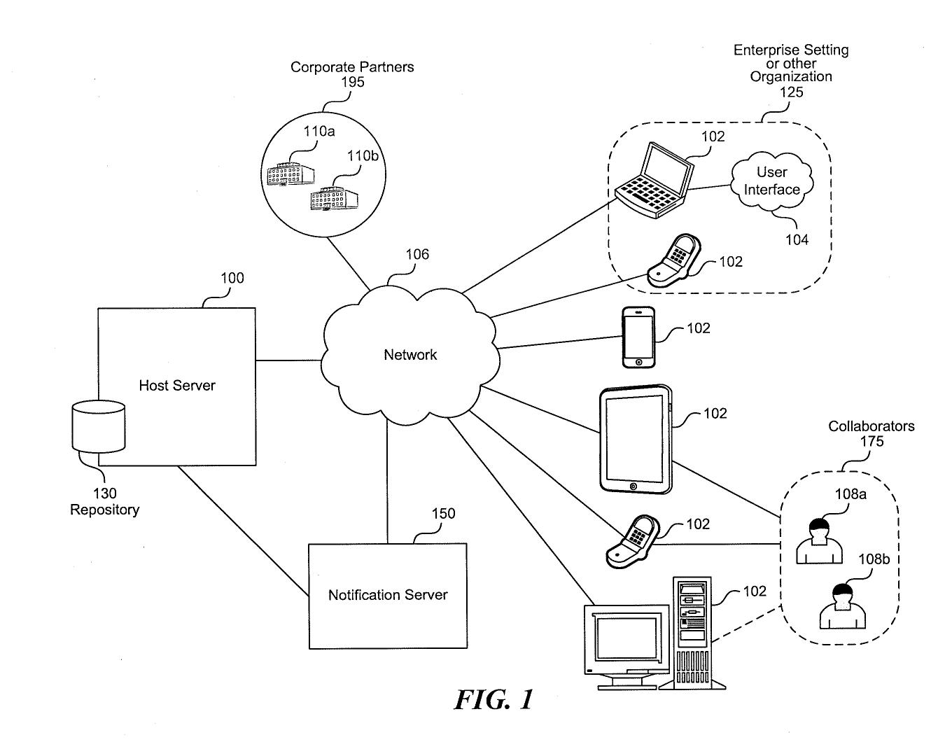

FIG. 1 illustrates an example diagram of a system having a host server 100 of a cloud service and/or cloud storage which is able to promote use and adoption through automatic account upgrades.

The client devices 102 can be any system and/or device, and/or any combination of devices/systems that is able to establish a connection, including wired, wireless, cellular connections with another device, a server and/or other systems such as host server 100 and/or notification server 150. Client devices 102 will typically include a display and/or other output functionalities to present information and data exchanged between among the devices 102 and/or the host server 100 and/or notification server 150.

For example, the client devices 102 can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. running on any platform or any operating system (e.g., Mac-based OS (OS X, iOS, etc.), Windows-based OS (Windows Mobile, Windows 7, etc.), Android, Blackberry OS, Embedded Linux platforms, Palm OS, Symbian platform. In one embodiment, the client devices 102, host server 100, and app server 110 are coupled via a network 106 and/or a network 108. In some embodiments, the devices 102 and host server 100 may be directly connected to one another.

The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

Signals received or detected indicating user activity at client devices 102 through one or more of the above input mechanism, or others, can be used in the disclosed technology by various users or collaborators (e.g., collaborators 108) for accessing, through network 106, a web-based collaboration environment or online collaboration platform (e.g., hosted by the host server 100).

The collaboration platform or environment hosts workspaces with work items that one or more users can access (e.g., view, edit, update, revise, comment, download, preview, tag, or otherwise manipulate, etc.). A work item can generally include any type of digital or electronic content that can be viewed or accessed via an electronic device (e.g., device 102). The digital content can include .pdf files, .doc, slides (e.g., Powerpoint slides), images, audio files, multimedia content, web pages, blogs, etc. A workspace can generally refer to any grouping of a set of digital content in the collaboration platform. The grouping can be created, identified, or specified by a user or through other means. This user may be a creator user or administrative user, for example.

In general, a workspace can be associated with a set of users or collaborators (e.g., collaborators 108) which have access to the content included therein. The levels of access (e.g., based on permissions or rules) of each user or collaborator to access the content in a given workspace may be the same or may vary among the users. Each user may have their own set of access rights to every piece of content in the workspace, or each user may be different access rights to different pieces of content. Access rights may be specified by a user associated with a work space and/or a user who created/uploaded a particular piece of content to the workspace, or any other designated user or collaborator.

In general, the collaboration platform allows multiple users or collaborators to access or collaborate efforts on work items such each user can see, remotely, edits, revisions, comments, or annotations being made to specific work items through their own user devices. For example, a user can upload a document to a work space for other users to access (e.g., for viewing, editing, commenting, signing-off, or otherwise manipulating). The user can login to the online platform and upload the document (or any other type of work item) to an existing work space or to a new work space. The document can be shared with existing users or collaborators in a work space.

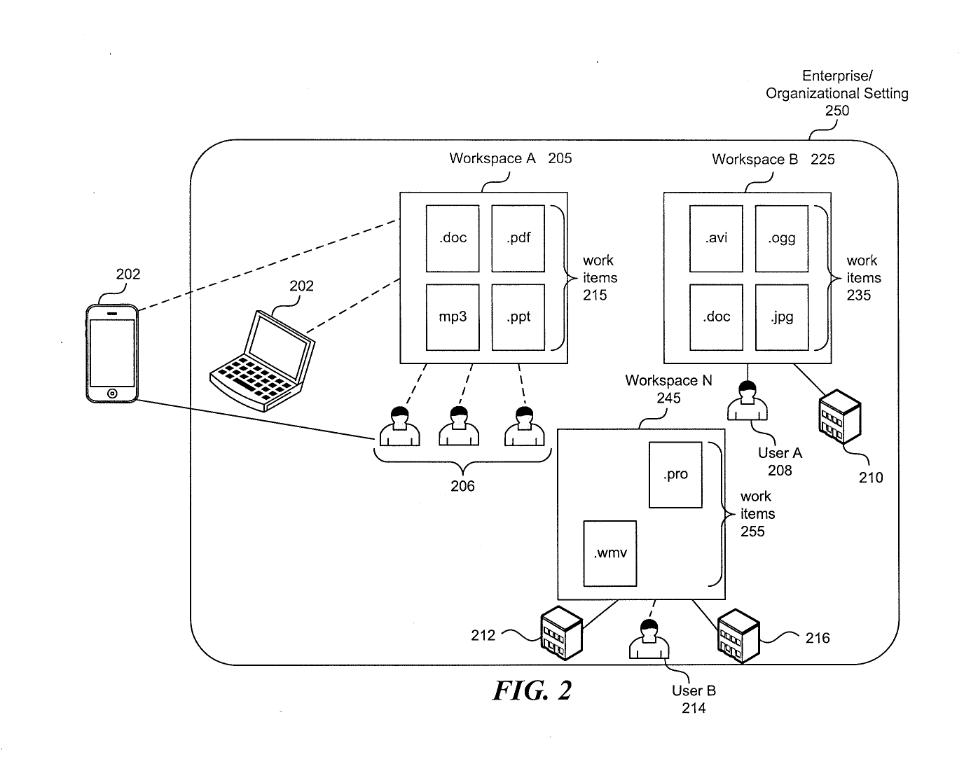

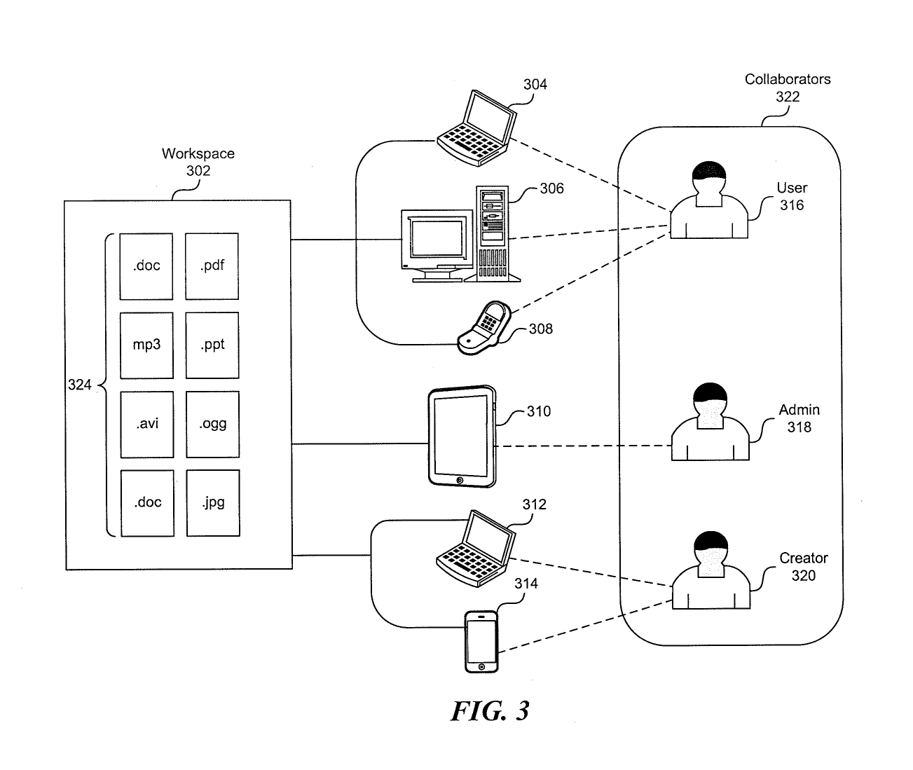

A diagrammatic illustration of the online collaboration environment and the relationships between workspaces and users/collaborators are illustrated with further reference to the example of FIG. 2. A diagrammatic illustration of a workspace having multiple work items with which collaborators can access through multiple devices is illustrated with further reference to the example of FIG. 3.

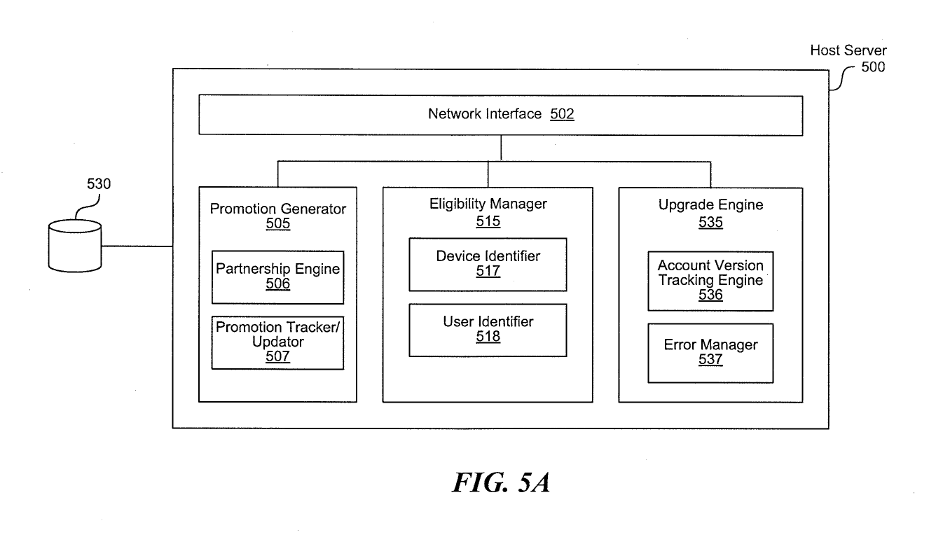

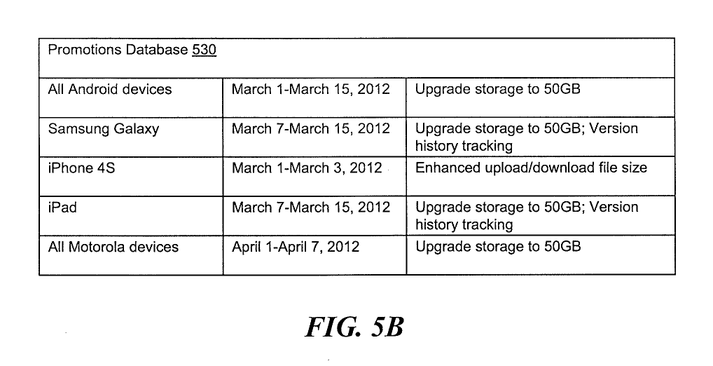

In one embodiment, the host server 100 of cloud-based services and/or cloud storage such as an online or web-based collaboration environment is able to promote its use and adoption through automatic upgrades of user accounts used to access the cloud services and/or storage. The automatic upgrades are, for instance, driven by partnerships or deals negotiated with entities such as corporate partners 195 including corporations and/or individuals. The terms of the partnerships and/or negotiated deals will determine parameters and/or details around various promotions specific to devices, manufacturers, and/or operating systems, or a combination of the above. Examples of promotions are listed in the example table shown in FIG. 5B.

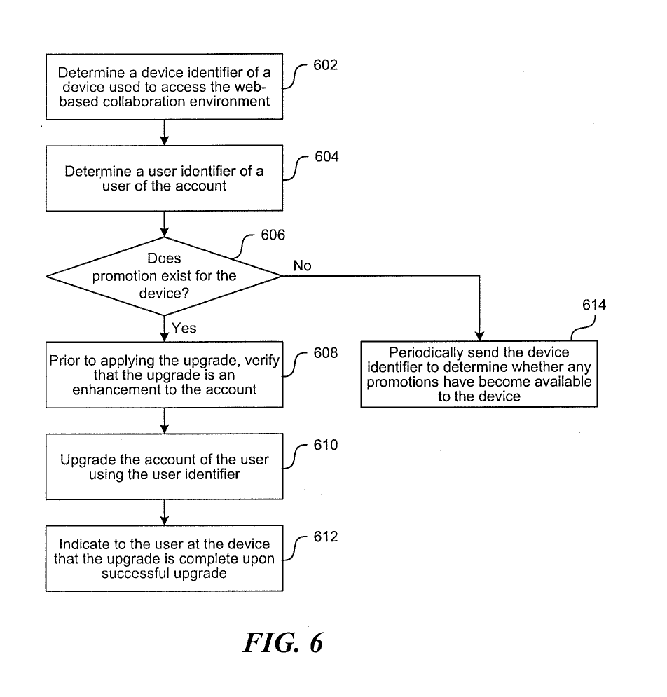

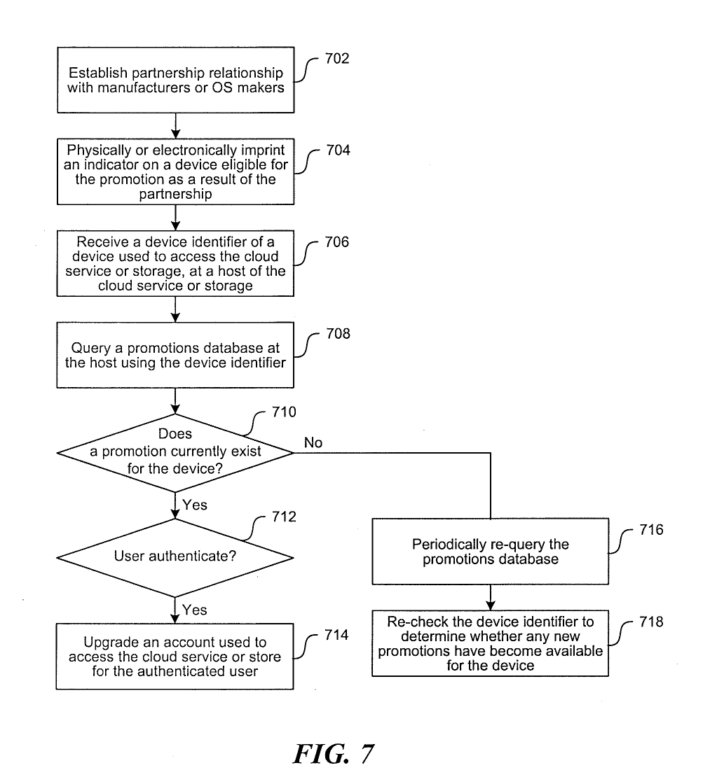

Functions and techniques disclosed for partnership driven device specific account upgrades to promote the use of cloud-based services and/or cloud storage are further described with reference to the components illustrated in the example of FIG. 5A. Functions and techniques performed by the host server 100 and/or other related components therein are described, respectively, in detail with further reference to the examples of FIG. 6-7.

In one embodiment, client devices 102 communicate with the host server 100 and/or notification server 150 over network 106. In general, network 106, over which the client devices 102, the host server 100, and/or notification server 150 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102 and the host server 100 and may appear as one or more networks to the serviced systems and devices. In one embodiment, communications to and from the client devices 102 can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, Wireless MAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, US SD, IRC, or any other wireless data networks or messaging protocols.

FIG. 2 depicts a diagram of a web-based or online collaboration platform deployed in an enterprise or other organizational setting 250 for organizing work items 215, 235, 255 and workspaces 205, 225, 245, as one example of a hosted cloud service and/or cloud storage in which accounts are automatically upgraded for certain devices.

The web-based platform for collaborating on projects or jointly working on documents can be used by individual users and shared among collaborators. In addition, the collaboration platform can be deployed in an organized setting including but not limited to, a company (e.g., an enterprise setting), a department in a company, an academic institution, a department in an academic institution, a class or course setting, or any other types of organizations or organized setting.

When deployed in a organizational setting, multiple workspaces (e.g., workspace A, B C) can be created to support different projects or a variety of work flows. Each workspace can have its own associate work items. For example, work space A 205 may be associated with work items 215, work space B 225 can be associated with work items 235, and work space N can be associated with work items 255. The work items 215, 235, and 255 may be unique to each work space but need not be. For example, a particular word document can be associated with only one work space (e.g., work space A 205) or it may be associated with multiple work spaces (e.g., Work space A 205 and work space B 225, etc.).

In general, each work space has a set of users or collaborators associated with it. For example, work space A 205 is associated with multiple users or collaborators 206. In some instances, work spaces deployed in an enterprise may be department specific. For example, work space B may be associated with department 210 and some users shown as example user A 208 and workspace N 245 can be associated with departments 212 and 216 and users shown as example user B 214.

Each user associated with a work space can generally access the work items associated with the work space. The level of access will depend on permissions associated with the specific work space, and/or with a specific work item. Permissions can be set for the work space or set individually on a per work item basis. For example, the creator of a work space (e.g., one of user A 208 who creates work space B) can set one permission setting applicable to all work items 235 for other associated users and/or users associated with the affiliate department 210, for example. Creator user A 208 may also set different permission settings for each work item, which may be the same for different users, or varying for different users.

In each work space A, B . . . N, when an action is performed on a work item by a given user or any other activity is detected in the work space, other users in the same work space may be notified (e.g., in real time or in near real time, or not in real time). Activities which trigger real time notifications can include, by way of example but not limitation, adding, deleting, or modifying collaborators in the work space, uploading, downloading, adding, deleting a work item in the work space, creating a discussion topic in the work space.

Specifically, items or content downloaded or edited in accordance with the techniques described in the present disclosure can be cause notifications to be generated. Such notifications can be sent to relevant users to notify them of actions surrounding a download, an edit, a change, a modification, a new file, a conflicting version, an upload of an edited or modified file.

In one embodiment, in a user interface to the web-based collaboration platform where notifications are presented, users can, via the same interface, create action items (e.g., tasks) and delegate the action items to other users including collaborators pertaining to a work item 215, for example. The collaborators 206 may be in the same workspace A 205 or the user may include a newly invited collaborator. Similarly, in the same user interface where discussion topics can be created in a work space (e.g., work space A, B or N, etc.), actionable events on work items can be created and/or delegated/assigned to other users such as collaborators of a given work space 206 or other users. Through the same user interface, task status and updates from multiple users or collaborators can be indicated and reflected. In some instances, the users can perform the tasks (e.g., review or approve or reject, etc.) via the same user interface.

FIG. 3 depicts an example diagram of a workspace 302 in an online or web-based collaboration environment accessible by multiple collaborators 322 through various devices which may be eligible for account upgrades.

Each of users 316, 318, and 320 can individually use multiple different devices to access and/or manipulate work items 324 in the work space 302 with which they are associated with. For example users 316, 318, 320 can be collaborators on a project to which work items 324 are relevant. Since the work items 324 are hosted by the collaboration environment (e.g., a cloud-based environment), each user can access the work items 324 anytime, and from any physical location using any device (e.g., including devices they own or any shared/public/loaner device).

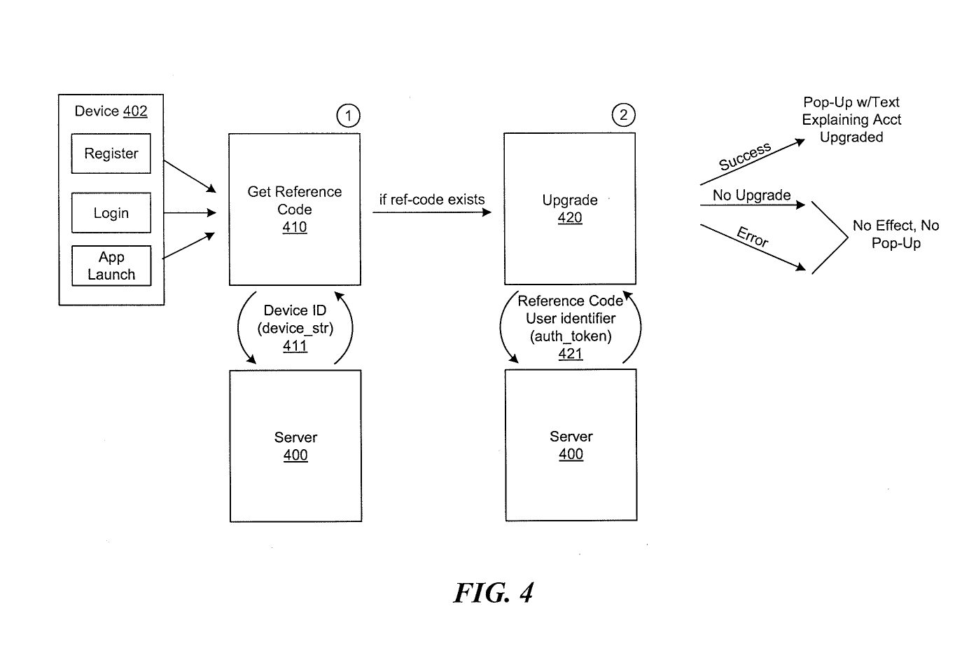

Work items to be edited or viewed can be accessed from the workspace 302 in accordance with the platform and/or application independent mechanisms disclosed herein, as further described with references to the examples of FIG. 4-13. Users can also be notified of access, edit, modification, and/or upload related-actions performed on work items 324 by other users or any other types of activities detected in the work space 302. For example, if user 316 modifies a document, one or both of the other collaborators 318 and 320 can be notified of the modification in real time, or near real-time, or not in real time. The notifications can be sent through any of all of the devices associated with a given user, in various formats including, one or more of, email, SMS, or via a pop-up window in a user interface in which the user uses to access the collaboration platform. In the event of multiple notifications, each notification can be depicted preferentially (e.g., ordering in the user interface) based on user preferences and/or relevance to the user (e.g., implicit or explicit).

For example, a notification of a download, access, read, write, edit, or uploaded related activities can be presented in a feed stream among other notifications through a user interface on the user device according to relevancy to the user determined based on current or recent activity of the user in the web-based collaboration environment.

In one embodiment, a notification feed stream includes updates when an invited user accepts an invitation and/or successfully creates a new account through receipt of an invitation from an existing user. The invited user, upon creation of the new account, receives the account having enhanced features. The new user can automatically be connected to the existing user who sent the invitation. The system can also automatically prompt both users to query they wish to be collaborators in a common work space.

FIG. 4 depicts a block diagram illustrating actions performed between a host server 400 for a cloud-based service and a user device 402 to authorize an automatic account upgrade that is specific to the device 402.

Through partnerships, promotions or account upgrades may be offered through device 402. For example, through a partnership, the device 402 may have been sold with a physical or electronic advertisement promoting the cloud-based service/storage hosted by server 400. The advertisement can indicate that if a user were to log in to an existing account, or register for a new account or simply launch an application on the device (device 402), that the new or existing account would be eligible for an upgrade.

When any of the above is triggered, an API call 410 can be made to obtain a reference code for a running promotion. The API call 410 is made with a device ID (device_str) 411 such that the server 400 can uniquely identify device 402 to verify eligibility.

If a reference code exists for a current promotion, an upgrade API 420 is called with the reference code identifying the promotion and/or a user identifier (e.g., a user authentication token or other forms of identification) to identify the account to upgrade. From this point, the upgrade successfully executes or an error message may be returned. For example, the upgrade may fail if the reference code identifying the promotion is no longer valid. In another instance the upgrade may fail if the enhancement specified in the promotion will actually be a downgrade for the account in question. In general, the account is checked to determine current features and/or version verification to confirm that an account upgrade will enhance features of the account, rather than downgrade the existing features.

FIG. 5A depicts a block diagram illustrating an example of components in a host server 500 able to promote the use and adoption of cloud service/storage via partnership driven automatic account upgrades.

The host server 500, in one embodiment, hosts a cloud based service and/or cloud based storage service which can include a cloud based collaboration and/or file sharing platform. The host server 500 can include, for example, a network interface 502, a promotion generator 505 having a partnership engine 506 and/or a promotion tracker/updator 507, an eligibility manager 515 having a device identifier 517, a user identifier 518, a upgrade engine 535 having an account version tracking engine 536 and/or an error manager 537. Additional or less components/modules/engines can be included in the host server 500 and each illustrated component.

The network interface 502 can be a networking module that enables the host server 500 to mediate data in a network with an entity that is external to the host server 500, through any known and/or convenient communications protocol supported by the host and the external entity. The network interface 502 can include one or more of a network adaptor card, a wireless network interface card (e.g., SMS interface, WiFi interface, interfaces for various generations of mobile communication standards including but not limited to 1G, 2G, 3G, 3.5G, 4G, LTE, etc.), Bluetooth, a router, an access point, a wireless router, a switch, a multilayer switch, a protocol converter, a gateway, a bridge, bridge router, a hub, a digital media receiver, and/or a repeater.

As used herein, a “module,” “a manager,” a “handler,” a “detector,” an “interface,” a “processor,” a “tracker,” a “detector,” a “generator,” a “launcher,” a “selector,” an “updator,” or an “engine” includes a general purpose, dedicated or shared processor and, typically, firmware or software modules that are executed by the processor. Depending upon implementation-specific or other considerations, the module, manager, hander, or engine can be centralized or its functionality distributed. The module, manager, hander, or engine can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

One embodiment of the host server 500 includes the promotion generator 505 which generates, creates, updates, modifies, promotions or other special events which allow people (e.g., those presently non users or present users) to create new accounts with special incentives. These incentives can include new accounts with special features or enhanced features which may be active for the lifetime of the account or for a certain time period of the account.

The promotion generator 505 can also generate device specific promotions for account holders or new account registrants based on partnering relationships with corporations. Since the host server 500 is generally a provider of cloud based services and/or cloud-storage services, adoption can be driven by partnering with device manufacturers and/or OS makers which provide the devices and/or platform through which users can access the hosted cloud services and/or cloud storage. In one embodiment, the partnership engine 506 can create strategic partnerships and promotions.

In general, promotions can be specific to a device manufacturer, a device model, an operating system (including mobile platforms such as iOS, Android, etc.) or any combination of the above. Promotions can be strategically generated based on the nature of the partnership and with a timing based on terms of the deal. In general, a promotion entails an upgrade of an existing account or the creation of a new account with enhanced features or added features. In general upgrading an account includes adding additional features or enhancing an existing feature, including but not limited to, adding additional storage space, enabling version history tracking or version rollback, higher maximum file size upload/download, additional bandwidth allocation, multiple folder download, real-time chat, real-time commenting, real-time notification, etc.

Each promotion can include any number of account enhancements or feature additions. In general, a promotion can have a timing parameter setting forth the time period within which a device is eligible for the upgrades. The timing parameter can be specified for when a device was purchased, when a user creates an account, when a user logs in to an existing account, and/or when the application is launched. The promotion tracker/updator 507 can track the details of each promotion (e.g., applicable account upgrades, eligible devices and/or OS's, eligible time period, etc.) and/or maintain the repository 530 with the promotional details.

The eligibility manager 515 can then receive requests from applications (e.g., desktop applications and/or mobile applications) used to access the hosted cloud service/storage to upgrade accounts. In one embodiment, the eligibility manager 515 determines a device identifier from a given request. In general, the device identifier uniquely identifies a device from which the cloud services are being accessed. In one embodiment, the device identifier is included in a string which includes device information regarding manufacturer, OS, version, device model, factory date, etc. This information can be aggregated by the end user application at the device side.

Using the device identifiers, the eligibility manager 515 can query the promotions database (e.g., repository 530) to determine whether a device is eligible for any current promotions. FIG. 5B depicts an example of promotions stored with promotion parameters and/or details of the promotion in a promotions database. The eligibility manager 515 can optionally use the user identifier 518 to identify the applicable account with which to upgrade, and/or to check any further eligibility requirements. The user identifier 518 may be used to verify user identity and to authenticate the user with the account prior to performing any upgrades.

Upon determination of eligibility of the device and/or identification of the applicable user account to the cloud service, the upgrade engine 535 applies the enhancements and/or additional features to the account, according to the relevant upgrades, which can include adding additional storage space, enabling version history tracking or version rollback, higher maximum file size upload/download, additional bandwidth allocation, multiple folder download, real-time chat, real-time commenting, real-time notification, etc.

In one embodiment, prior to applying upgrades to an account or otherwise making any changes, the system performs a check on the account status and version to determine whether the specified upgrade in the promotion will actually be an enhancement (e.g. an added feature or enhancing a current feature accessible to the account). Given that different accounts may have different features, the check ensures that if an account currently has 100 GB of storage, even if a promotion calls for an upgrade to 50 GB of storage, and the account is eligible for the promotion, that the account does not actually get downgraded to having 50 GB of storage from 100 GB of storage.

In this instance, error manager 537 may generate an error to be returned to the host or device, with no changes made to the account. In one embodiment, the system may automatically upgrade the account in another manner, for example, to automatically increase the storage from 100 GB to 120 GB, or to apply another current upgrade (e.g., to include a new feature such as version history tracking, version roll back, real-time chat, notifications etc.). Once an account has been successfully upgraded, the upgrade engine 535 can generate a notification to be presented to the user at the end device.

FIG. 6 depicts a flow chart illustrating an example process for automatically upgrading an account to cloud-based services and/or storage based on device-specific promotions.

In process 602, a device identifier of a device used to access the web-based collaboration environment is determined. The device identifier can be, identified at the device by an application (e.g., a mobile application or widget) used to access the web-based collaboration environment, or more generally, any cloud-based service and/or storage. For example, the device identifier can automatically be retrieved when a user registers for an account or logs in via an existing account in the web-based collaboration platform or other hosted cloud environment. In addition, the device identifier can also be retrieved when an application to access the web-based collaboration environment is launched on the device.

In general, the device identifier is used to determine whether a promotion exists for the device. For example, the device identifier can include a code or string which (e.g., a device string) which uniquely identifies the device in question. The device identifier can include information regarding one or more of, device parameters, OS parameters, and/or identification of the device manufacturer. Any of these parameters or any combination of these parameters may be used to determine the eligibility of a given device for existing promotions. For example, parameters of eligibility for the promotion include, one or more of, device parameters, OS parameters, device manufacturers. In addition, promotions can also include a timing parameter which sets for the start and end dates of the promotion.

In process 604, a user identifier of a user of the account is determined. The user identifier can include user login credentials used to verify the user's account and/or identity of the user. The user identifier can be retrieved by the application before or after verification of a currently existing and applicable promotion. In some instances, the user identifier can be sent to a host server (e.g., a host of the promoted cloud service and/or storage) along with the device identifier for verification and/or identification of applicable promotions.

In one embodiment, the device identifier and/or the user identifier is sent in response to access of the web-based collaboration environment at the device. For example, in one use case, a user may learn of a promotion for use or access of the cloud service or storage through an advertisement physically printed or electronically depicted (e.g., on their device or delivered to them through an online account—Twitter, Facebook, email, etc.). The user can then register for an account or login to an existing account to the cloud service and/or storage in response to viewing the promotion. When the user registers or logs in, the device or the mobile application on the device sends the device identifier and/or the user identifier to begin the account upgrade process.

In decision flow 606, it is determined whether a promotion exists for the device. In general, the device identifier is checked at a server (e.g., a server for the cloud service and/or storage or other server) for applicable promotions. If not, the flow continues to process 614 where the device identifier is periodically sent (e.g., by the application on the device) to determine whether any promotions have become available to the device or user. The device identifier can be periodically sent to the host of the cloud service/storage which checks for any new applicable promotions. Alternatively, the device identifier for which no current promotions are applicable, can be retained automatically at the host for periodic re-checking.

If a promotion exists and is still valid (e.g., still within a promotional period), it is verified that the upgrade, if performed, would be an enhancement to the account prior in process 608. In general, prior to making changes to the account, or applying any specified upgrades in a promotion, the host verifies that the upgrade would be an enhancement (e.g., including an added feature and/or enhances an existing feature of the account). If verified, the account of the user is upgraded using the user identifier in process 610. For example, if the specified upgrade increases the storage capacity to 50 GB, the host of the cloud service/storage will determine whether the account in question has storage less than 50 GB. If the account already has 50 GB of storage or greater than 50 GB of storage, then the change may not be applied. Alternatively, the account may be upgraded to some other type of enhancement, e.g., to 60 GB or to have an upgrade to another feature or to add a new feature to the account. The account change may simply return an error in this situation without applying changes to the account absent further instructions.

In process 612, upon successful upgrade and/or making the applicable account changes, completion of the upgrade is indicated to the user at the device. In general, account upgrades can include any enhancement including access to new/additional features, existing features with enhancements, additional access rights, user interface enhancements, functionality enhancements and/or aesthetics enhancements, or any combination of the above.

Some examples of upgrade include by way of example but not limitation, additional storage space for the account, version history tracking, higher maximum file size upload or download to cloud storage accessed using the account, download multiple folders or to download the contents of an entire folder from the cloud storage access using the account, etc. Additional examples of upgrades can also include interactive features, social features, real-time features such as real-time notification of activities, chat features, real-time commenting features, AV capabilities such as enhancements or features supporting audio and/or video file sharing, collaboration or editing.

FIG. 7 depicts a flow chart illustrating an example process for promoting use of cloud service and/or storage through partnership-driven automatic account upgrades.

In process 702, partnership relationship with manufacturers or OS makers is established. For example, specific devices eligible for promotion or for account upgrade can be selected based on partnership relationships with device manufacturers or OS makers. In general, promotions can be specific to one or more of, a manufacturer of the device, model of the device, and/or an operating system of the device including Android or iOS.

In process 704, an indicator is imprinted on a device eligible for the promotion as a result of the partnership, to promote use or adoption of the cloud service or storage. In one embodiment, the cloud service or storage is provided in the context of a web-based collaboration environment, a cloud-based file sharing service, a cloud-based storage service, or any other types of cloud-based services and/or cloud-based storage. In process 706, a device identifier of a device used to access the cloud service or storage, is received at a host of the cloud service or storage.

In process 708, a promotions database (e.g., a database illustrated in the example of FIG. 5B) is queried at the host using the device identifier. In process 710, it is determined whether a promotion currently exists for the device. If so, in process 712, it can be optionally determined whether the user can be authenticated (e.g., whether the user has submitted valid credentials to access or login to an existing account). If the user has just registered for a new account, this step may not be performed. If so, an account used to access the cloud service or storage for the authenticated user is upgraded in step 714. If a promotion does not currently exist, the promotions database is periodically re-queried in process 718 to recheck the device identifier to determine whether any new promotions have become available for the device, as in step 720.

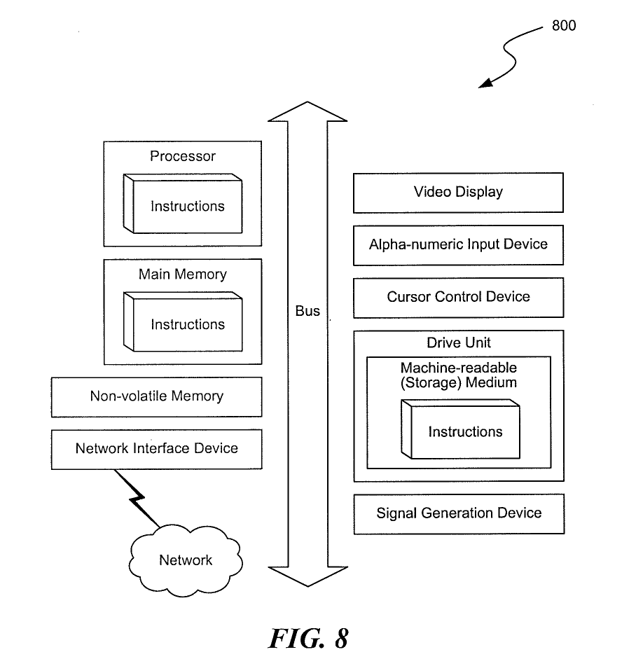

FIG. 8 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 2800 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

What is claimed is:

1. A method for automatically upgrading an account in a web-based collaboration environment, the method, comprising:
determining a device identifier of a device used to access the web-based collaboration environment and a user identifier of a user of the account;
wherein, the device identifier is used to determine whether a promotion exists for the device;
wherein, the user identifier is used to upgrade the account of the user when the promotion exists for the device used to access the web-based collaboration environment.

2. The method of claim 1, wherein, parameters of eligibility for the promotion include, one or more of, device parameters, OS parameters, device manufacturers.

3. The method of claim 1, wherein, parameters of eligibility for the promotion includes a time period for the promotion.

4. The method of claim 1, further comprising, upgrading the account and indicating to the user at the device that the upgrade is complete upon successful upgrade.

5. The method of claim 1, further comprising, prior to applying the upgrade, verifying that the upgrade is an enhancement to the account including an added feature or an enhanced feature.

6. The method of claim 1, further comprising, periodically sending the device identifier to determine whether any promotions have become available to the device.

7. The method of claim 1, wherein, the upgrade includes additional storage space for the account.

8. The method of claim 1, wherein, the upgrade includes version history tracking.

9. The method of claim 1, wherein, the upgrade includes a higher maximum file size upload or download to cloud storage accessed using the account.

10. The method of claim 1, wherein, the upgrade includes a feature to download multiple folders or to download the contents of an entire folder from the cloud storage access using the account.

11. The method of claim 1, wherein, the identifier is sent in response to access of the web-based collaboration environment at the device.

12. The method of claim 11, wherein, the access includes, registration for the account in the web-based collaboration environment.

13. The method of claim 11, wherein, the access includes, login to the web-based collaboration environment.

14. The method of claim 11, wherein, the access includes launching an application to access the web-based collaboration environment.

15. The method of claim 1, wherein, the web-based collaboration environment is accessed using a mobile application installed at the device, wherein, the device is a portable device.

16. The method of claim 1, wherein, the portable device is a tablet or smart phone.

17. A method for promoting use of cloud service or storage via specific devices, the method, comprising:
receiving a device identifier of a device used to access the cloud service or storage, at a host of the cloud service or storage;
using the device identifier, by the host, to determine whether a promotion currently exists for the device and for identifying details of the promotion;
responsive to determining that the promotion exists, upgrading an account used to access the cloud service or storage;
wherein, the use of the cloud service or storage is promoted at the device by a physical or electronic imprint depicting the promotion available when accessed at the device.

18. The method of claim 17, wherein, the account is upgraded responsive to authentication of a user of the account.

19. The method of claim 17, wherein, the cloud service or storage is provided in the context of a web-based collaboration environment.

20. The method of claim 17, wherein, the specific devices are selected based on partnership relationships with device manufacturers or OS makers.

21. The method of claim 17, wherein, the details of the promotion indicate account enhancements applicable to the upgrade.

22. The method of claim 17, wherein, the promotion is specific to a manufacturer of the device.

23. The method of claim 17, wherein, the promotion is specific to a model of the device.

24. The method of claim 17, wherein, the promotion is specific to an operating system of the device including Android or iOS.

25. The method of claim 17, further comprising, responsive to determining that a promotion does not exist for the device, subsequently periodically re-checking the device identifier to determine whether any promotions have become available or the device.

26. A system for promoting use of cloud service or storage via specific devices, the system, comprising:
a processing unit;
a memory unit having stored thereon instructions which when executed by the processing unit, causes the processing unit to:
use a device identifier to determine whether a promotion exists for device and for identifying details of the promotion;
wherein, the device identifier identifies a device used to access the cloud service or storage;
verifies that the upgrade is an enhancement to the account including an added feature or an enhanced feature, prior to applying the upgrade when determined that the promotion exists.

27. The system of claim 26, wherein, the processing unit upgrades an account used to access the cloud service or storage at the device, if the upgrade is verified to be an enhancement to the account.

28. The system of claim 26, wherein, the use of the cloud service or storage is promoted at the device by a physical or electronic imprint depicting the promotion available when accessed at the device.

29. The system of claim 26, wherein, parameters of eligibility for the promotion include, one or more of, device parameters, OS parameters, device manufacturers.

30. The system of claim 26, wherein, parameters of eligibility for the promotion includes a time period for the promotion.
